(19) United States
(12) Patent Application Publication
(10) Pub. No.: US 2014/0004839 A1
(43) Pub. Date: Jan. 2, 2014

(54) PROXIMITY BASED TRANSFER

(71) Applicants: Frederick P. BLOCK, Westminster, CO (US); Dennis C. EPISKOPOS, Westminster, CO (US); Paul A. FULLARTON, Sunnyvale, CA (US); Scott B. STEELE, Naperville, IL (US)

(72) Inventors: Frederick P. BLOCK, Westminster, CO (US); Dennis C. EPISKOPOS, Westminster, CO (US); Paul A. FULLARTON, Sunnyvale, CA (US); Scott B. STEELE, Naperville, IL (US)

(21) Appl. No.: 13/539,248

(22) Filed: Jun. 29, 2012

(51) Int. Cl. H04M 3/54

(52) U.S. Cl. CPC H04M 3/54
USPC 455/417; 379/212.01

(57) ABSTRACT

A method for transferring a data stream between devices on a network is initiated by one of the devices. The devices on the network include a first device requesting the transfer and a second device currently receiving the data stream via the network. The method steps include a first device determining a proximity to a second device. The method steps also include the first device initiating a command to terminate a data stream received by the second device via a network when the proximity is below a threshold; and the first device initiating a command to transfer the data stream via the network so that the data stream is received by the first device.

### TECHNICAL FIELD

Embodiments of this present disclosure relate generally to the field of audio and video telecommunications and more specifically to the field of call transfer methods.

### BACKGROUND

Conventional telephone networks allow a variety of users to interconnect regardless of the type of service they may be using. For example, telephone users may place and receive telephone calls via conventional public circuit-switched telephone networks. Such telephone networks allow telephone users to place and receive calls to or from any other telephone connected to the public switched telephone network (PSTN). Telephone users may also place and receive calls via voice over internet protocol (VoIP) services. Conventional VoIP services may allow the transmission of voice communications and multimedia sessions over Internet Protocol (IP) networks (e.g., the Internet). Telephone users may also place and receive calls with telephones that are connected to the PSTN via a private branch exchange (PBX). A business telephone system may be implemented through a PBX telephone network that may include a variety of interconnected telephones, fax machines, and modems, for example. A business telephone system utilizing a PBX telephone network may be a computer implemented exchange (IP-PBX), where voice calls are handled through internet protocols using either conventional hardware or virtual hardware.

A first telephone device engaged in a telephone call with a second telephone device may transfer the telephone call from the first telephone device to a third telephone device. The second telephone device may also transfer the telephone call from the second telephone device to a fourth telephone device. However, conventionally, such a transfer requires the current telephone call to be placed on hold and the telephone call transferred to the third telephone device (e.g., after placing the telephone call on hold, the third telephone device is called so that the third telephone device may pick up the telephone call). Such call transferring will not be transparent to the other party taking part in the telephone call (e.g., the party using the second telephone device), as the telephone call will be placed on hold until the telephone call is again established with the new telephone device (e.g., the third telephone device).

A conventional PBX network may allow telephone calls to be transferred between a telephone device on the PBX network (e.g., a work phone) and an associated cell phone, where the work phone and the cell phone are both telephone devices registered to a single user. Such an implementation may treat a user's cell phone as a bridged line appearance of the user's work phone, allowing a call currently active on the cell phone to be picked up on the corresponding work phone line appearance. However, such an operation is limited to transferring certain calls from the user's cell phone to the user's work phone. Such calls include incoming calls to the user's work phone that were answered on the user's cell phone, or outbound calls made from the user's cell phone to a destination phone served by the same PBX as the user's work phone. Therefore, conventional phone networks are only able to manually transfer a current call from the user's work phone to the user's cell phone. As noted above, such a manual transfer generally requires putting the current call on hold and dialing the user's cell phone number. In all likelihood, such an operation will be noticeable to other parties on the call.

### SUMMARY OF THE DISCLOSURE

Embodiments of this present disclosure provide solutions to the challenges inherent in transparently and non-disruptively transferring an existing media/data session or stream, such as an audio and/or video call, or web conference, from one device to another. In a method according to one embodiment of the present disclosure, transferring a media/data session or stream comprises locating a media/data session or stream available for transfer as defined by a detected proximity in response to a request to initiate the transfer on a desired device. In exemplary embodiments, proximity detection may comprise GPS positioning, geo-presence, a near-field communication linkage, a Bluetooth wireless interconnection, a common Wi-Fi access point, and Wi-Fi or Cellular network triangulation mechanisms.

In a method according to one embodiment of the present disclosure, a method for transferring a data stream between telephone devices on a telephone network is disclosed. The method is initiated by one of the telephone devices on the telephone network. The telephone devices on the telephone network include a first device requesting the transfer and a second device currently receiving the data stream via the telephone network. The method includes the first device determining a proximity to the second device. The method also includes the first device initiating a command to terminate a data stream received by the second device via a network when the proximity is below a threshold; and the first device initiating a command to transfer the data stream via the network so that the data stream is received by the first device.

In an apparatus according to one embodiment of the present disclosure, a communications apparatus is disclosed. The communications apparatus comprises a transceiver and a processor. The transceiver is operable to receive a data stream via a network. The processor is operable to determine a proximity to a second communications apparatus. The process is also operable to initiate a request to terminate a first data stream received by the second communications apparatus when the proximity is below a threshold. Lastly, the processor is also operable to initiate a request to transfer the first data stream via the network so that the communications apparatus receives the first data stream.

### BRIEF DESCRIPTION OF THE DRAWINGS

The present disclosure will be better understood from the following detailed description, taken in conjunction with the accompanying drawing figures in which like reference characters designate like elements and in which:

FIG. 1 illustrates a simplified exemplary communications network with interconnecting telephonic devices in accordance with an embodiment of the present disclosure;

FIG. 2A illustrates a simplified proximity diagram for detecting existing data streams for transferring a detected existing data stream from one device to another in accordance with an embodiment of the present disclosure;

FIG. 2B illustrates a simplified proximity diagram for detecting existing data streams for transferring a detected existing data stream from one device to another in accordance with an embodiment of the present disclosure;

FIG. 3 illustrates a simplified proximity diagram for detecting existing data streams for transferring a detected existing data stream from one device to another in accordance with an embodiment of the present disclosure;

FIG. 4 illustrates a simplified diagram for transferring an existing audio/video stream from one device to a pair of devices in accordance with an embodiment of the present disclosure;

FIG. 5 illustrates a flow diagram, illustrating steps to a method for detecting existing data streams for transferring a detected existing data stream from one device to another in accordance with an embodiment of the present disclosure; and

FIG. 6 illustrates an exemplary wireless telephonic device in accordance with an embodiment of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments described herein may be discussed in the general context of computer-executable instructions, such as program modules, residing on some form of computer-readable storage medium executed by one or more computers or other devices. By way of example, and not limitation, computer-readable storage media may comprise non-transitory computer-readable storage media. Non-transitory computer-readable storage media includes all computer-readable media except for a transitory, propagating signal. Computer-readable storage media includes volatile and nonvolatile, removable and non-removable media implemented in any method or technology for storage of information such as computer-readable instructions, data structures, program modules or other data. Generally, program modules include routines, programs, objects, components, data structures, etc., that perform particular tasks or implement particular abstract data types. The functionality of the program modules may be combined or distributed as desired in various embodiments.

This present disclosure provides a solution to the increasing challenges inherent in managing voice, audio/video, and/or data sessions carried over telephone networks. Various embodiments of the present disclosure provide transparent transferring of data streams (e.g., voice, audio/video, and data sessions) from a first device to a second device via the telephone network. The transfer of the voice, audio/video, and/or data session may be executed without disrupting a second party to the voice, audio/video, and/or data session. In other words, the transfer will be transparent to the second party. As discussed herein, when a geolocation of the first device is within a proximity threshold of the second device, a transfer request may be issued for execution by the telephone network.

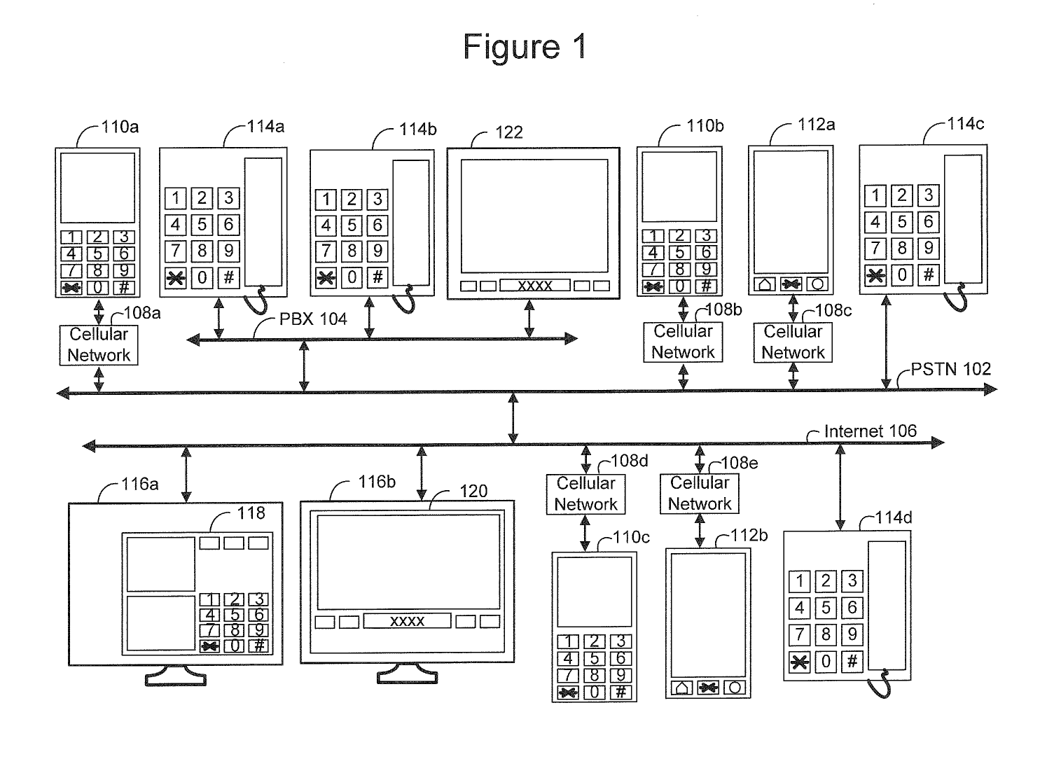

FIG. 1 illustrates a variety of interconnected telecommunication devices on a variety of networks that may send or receive audio, audio/video, and/or data sessions. As discussed herein, audio, audio/video, and/or data sessions may include, for example, audio telephone calls, streaming multimedia sessions, streaming audio/video, and web conference sessions. As illustrated in FIG. 1, a public switched telephone network (PSTN) 102 may be interconnected with a business telephone system such as a multi-line system or a private branch exchange (PBX) 104. In one exemplary embodiment, the PBX 104 may be implemented as a computer implemented exchange (IP-PBX), where voice calls are handled through internet protocols using either hardware or virtual hardware. The PSTN 102 may also be interconnected with internet protocol (IP) networks (e.g., the Internet) 106. The PSTN 102 and the Internet 106 may also be interconnected by cellular networks 108a-108e.

Cell phones 110a-110c and smart cell phones 112a and 112b may be connected to the PSTN telephone network 102 and the Internet 106 through cellular networks 108a-108e. Telephones 114a and 114b may be connected to the PBX network 104. In one embodiment Telephone 114c may be connected to the PSTN telephone network 102. Telephone 114d may also be connected to the PSTN telephone network 102 via the Internet 106. In one exemplary embodiment, computer devices 116a and 116b may be connected to the Internet 106. In one exemplary embodiment, the computer device 116a is running an instance of an exemplary computer-based virtual phone 118, while the computer device 116b is running an instance of a computer-based audio/video conferencing program 120, both provided through VoIP services. In one exemplary embodiment, the virtual phone 118 and/or the audio/video conferencing program 120 may be implemented using web browsers that are capable of providing web-based real-time communication endpoints. Therefore, a variety of telephone calls, streaming audio sessions, and audio/video sessions may be initiated using a variety of telephones 114, cell phones 110, smart cell phones 112, and computers 116 that are interconnected via a PSTN telephone network 102, a PBX network 104, the Internet 106, and cellular networks 108. In one exemplary embodiment, a computer 116 may be any computer device, for example: a desktop computer, a notebook computer, a laptop computer, or a tablet computer, etc.

In one exemplary embodiment, an audio, audio/video, and/or data session may be transferred between a telecommunications device on a PBX network 104 and another telecommunications device. For example, an audio session may be transferred between a telephone 114a and a cell phone 110a. In another embodiment, an audio, audio/video, and/or data session may be transferred between a smart phone 112a and a virtual phone 118 or a computer-based audio/video conferencing program 120. In another embodiment, as illustrated in FIG. 1, an audio/video conferencing device 122 may be connected to the PBX network 104. In one embodiment, the audio, audio/video, and/or data session may be transferred from the device that initiated the session, while in another embodiment, the audio, audio/video, and/or data session may be transferred from the device that was receiving the session. As discussed in detail herein, in one exemplary embodiment, the audio, audio/video, and/or data session may be transferred to a device that requested the transfer.

In one embodiment, audio, audio/video, and/or data sessions may be transferred between multiple telephonic devices (virtual or hardware). In other words, an audio, audio/video, and/or data session may be transferred from a telephonic device to any one of several other telephonic devices. In one embodiment, each telephonic device to which the audio, audio/video, and/or data session may be transferred to or from is registered to a common user. In other words, the telephonic device from which the audio, audio/video, and/or data session is transferred is registered to the same user as the telephonic device to which the audio, audio/video, and/or data session is transferred). In one embodiment, a user registration comprises a user name. In one embodiment, a user registration comprises a user name and a password.

In one embodiment, each telephonic device (virtual or hardware) stores a list of any other telephonic devices registered to the same user. In one embodiment, as described herein, to facilitate an audio, audio/video, and/or data session transfer, a list of telephonic devices registered to the user is referred to and if one of the registered telephonic devices (e.g., a requesting device) is within a pre-defined distance from a telephonic device currently receiving an audio, audio/video, and/or data session (e.g., a receiving device), the current audio, audio/video, and/or data session may be transferred to the requesting device within the defined distance. In one embodiment, telephonic devices (e.g., a receiving device and a requesting device) are a pre-defined distance apart when determined geolocations of the telephonic devices are within a proximity threshold. As discussed herein, a geolocation may be a geographical location of a cell phone, an internet-connected computer system, or other telecommunications device where a geographical location may be determined. In one exemplary embodiment, a geolocation of a device may be determined by associating a physical location of the device with an interne protocol (IP) address, an RFID wireless connection, a Wi-Fi access location, or GPS coordinates of the device, for example.

In one embodiment, a pair of telephonic devices (e.g., a receiving device and a requesting device) is less than a pre-defined distance apart when the pair of telephonic devices are linked by a near-field communications link or a Bluetooth communications link. In one embodiment, the pair of telephonic devices is linked by a near-field communications link when the pair of telephonic devices is physically touching.

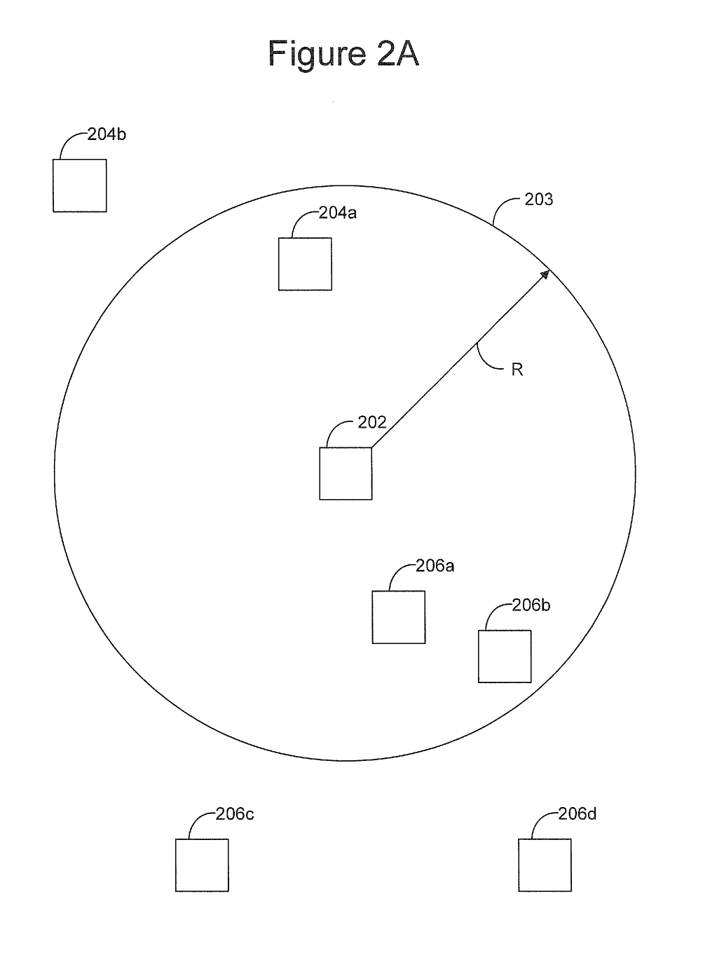

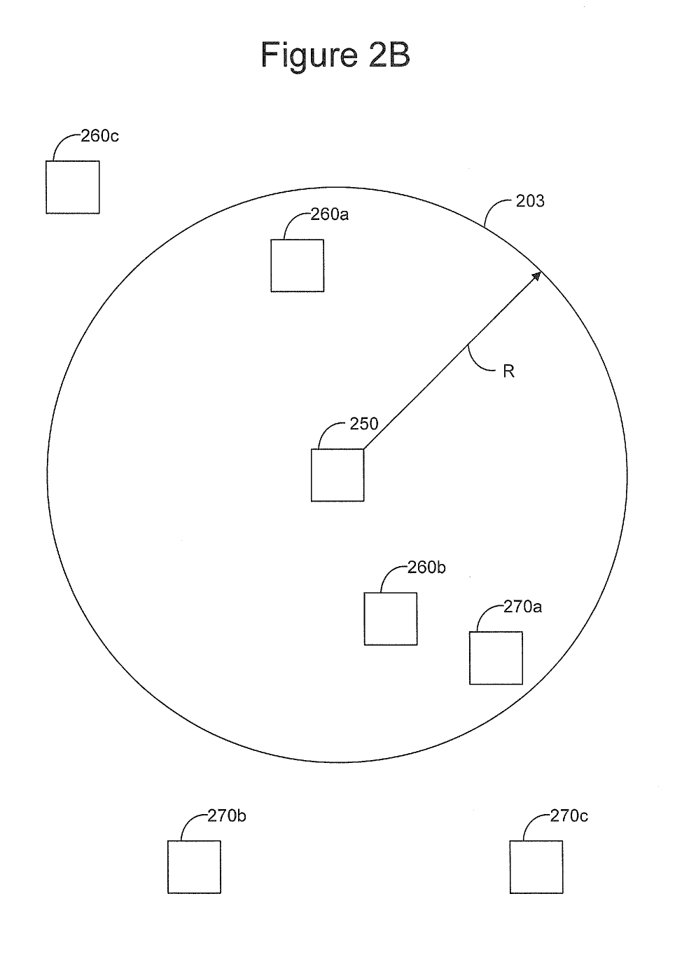

FIG. 2A illustrates an exemplary telephonic device 202 currently receiving a streaming audio, audio/video, and/or data session, and a plurality of telephonic devices 204a and 204b registered to the same user as the telephonic device 202, as well as a plurality of other telephonic devices 206a-206d that are not registered to the user. In one embodiment, the telephonic devices 202, 204, and 206 may be for example, a cell phone 110, a smart cell phone 112, an analog telephone 114, a virtual telephone 118, or an audio/video conferencing device 120, 122. As illustrated in FIG. 2A, the current streaming session received by telephonic device 202 may be transferred to the telephonic device 204a, which is within the radius R.

In one embodiment, FIG. 2A illustrates an exemplary Bluetooth communications link with the telephonic device 202 or a near-field communications link. The envelope 203, illustrated in FIG. 2A, is the range of coverage of the exemplary Bluetooth communication link or near-field communications link. In one embodiment, FIG. 2A illustrates a defined distance threshold or proximity threshold, radius R, and a corresponding area 203 surrounding a telephonic device 202 that is currently receiving the streaming audio, audio/video, and/or data session. Radius R represents a maximum distance or proximity threshold between a geolocation of the receiving telephonic device 202 and a geolocation of another requesting telephonic device 204 that is registered to the same user.

In one exemplary embodiment, radius R may be approximately 10-30 feet, such that the desired distance or proximity threshold allows the pair of telephonic devices 202 and 204 to be within a room. In another exemplary embodiment, radius R may be approximately 2-5 feet, such that the desired distance or proximity threshold allows the pair of telephonic devices 202 and 204 to be within an automobile or on a desk. In another exemplary embodiment, radius R may be such that the pair of telephonic devices 202 and 204 are touching or within 1-10 centimeters apart.

FIG. 2B illustrates an exemplary telephonic device 250 currently requesting a transfer of a streaming audio, audio/video, and/or data session, and a plurality of telephonic devices 260a and 260b registered to the same user as telephonic device 250 that is currently receiving a streaming audio, audio/video, and/or data session. FIG. 2B also illustrates a plurality of other telephonic devices 270a-270c that is not registered to the same user. As illustrated in FIG. 2B, two different streaming audio, audio/video, and/or data sessions, as received by telephonic devices 260a and 260b are within a radius R, and able to be transferred to the requesting telephonic device 250. For example, a streaming audio session received by a computer and a streaming audio/video session received by another telephonic device, which are both in the same room, may be transferred to a requesting telephonic device upon the requesting telephonic device enters the room and enters the radius R, as discussed herein.

In one embodiment, FIG. 2B illustrates an exemplary Bluetooth communications link with the telephonic device 250 or a near-field communications link. The envelope 203, illustrated in FIG. 2B, is the range of coverage of the exemplary Bluetooth communication link or near-field communications link. In one embodiment, FIG. 2B illustrates a defined distance threshold or proximity threshold, radius R, and a corresponding area 203 surrounding a telephonic device 250 that is currently requesting transfer of a streaming audio, audio/video, and/or data session. Radius R represents a maximum distance or proximity threshold between a geolocation of the requesting telephonic device 250 and a geolocation of a receiving telephonic device 260a, 206b that is registered to the same user. In one exemplary embodiment, a pair of telephonic devices are within the defined distance threshold or proximity threshold when they have achieved a Bluetooth pairing.

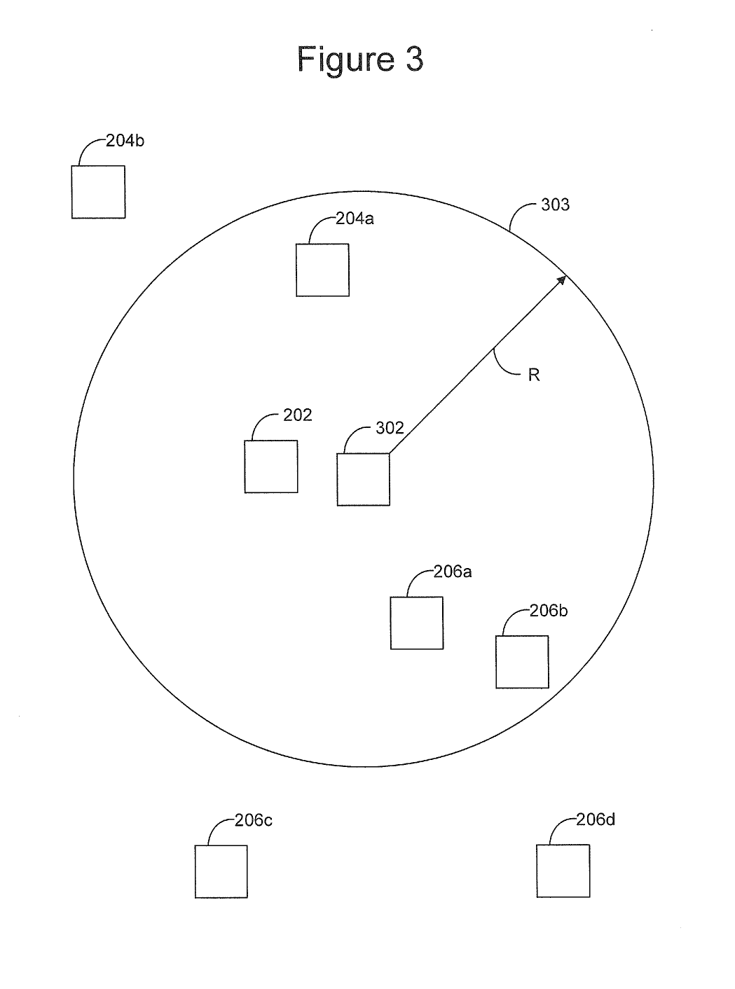

FIG. 3 illustrates an exemplary embodiment, where a defined minimum distance or proximity threshold may be defined by both telephonic devices 202 and 204a connected to a same Wi-Fi access point 302. As illustrated in FIG. 3, an exemplary Wi-Fi access point 302 has a radius R and a coverage area 303 for the Wi-Fi access point 302. As discussed herein, the pair of telephonic devices 202 and 204 is within a defined minimum distance apart or within a proximity threshold radius R when both telephonic devices 202 and 204a are connected to the same Wi-Fi access point 302. As illustrated in FIG. 3, telephonic devices 202 and 204a are both connected to Wi-Fi access point 302. As discussed herein, the telephonic devices 202 and 204a are both registered to a same user.

In FIG. 3, telephonic device 202 is currently receiving a streaming audio, audio/video, and/or data session, for example, while telephonic device 204a may be requesting the transfer. The telephonic device 204b is registered to the same user as telephonic device 202, but is outside of the minimum distance or proximity threshold R. Telephonic devices 206a and 206b, as illustrated in FIG. 3, are within the minimum distance or proximity threshold R, but are not registered to the same user as telephonic device 202. Meanwhile, telephonic devices 206c and 206d are both outside the minimum distance or proximity threshold R and not registered to the same user as telephonic device 202. Therefore, as discussed herein, a streaming audio, audio/video, and/or data session may only be transferred between telephonic devices 202 and 204a.

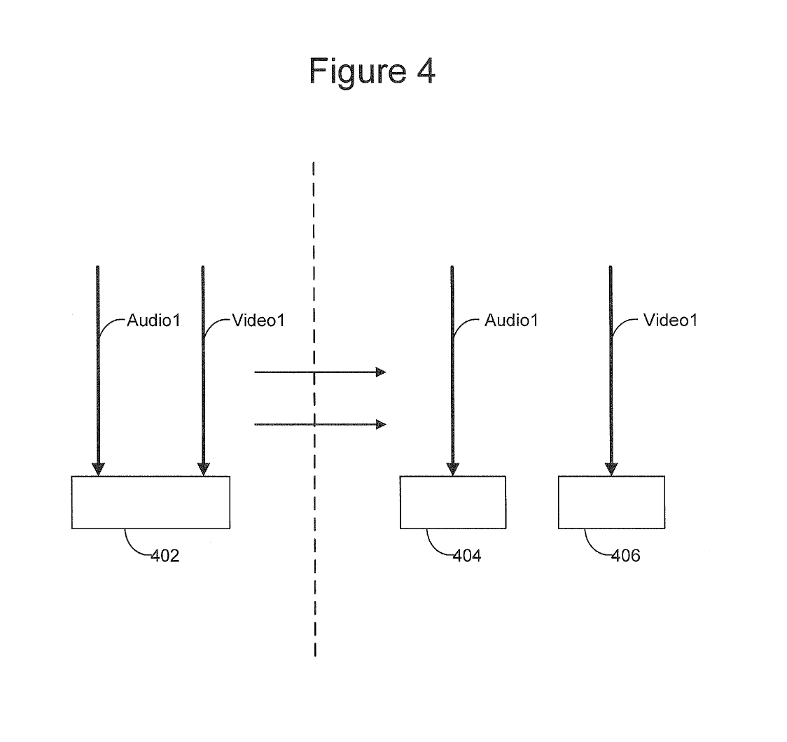

FIG. 4 illustrates an exemplary embodiment where streaming audio session Audio1 and video session Video1, received by a first telephonic device 402, may be transferred to a pair of telephonic devices 404 and 406 that are registered to the same user as the first telephonic device 402. As illustrated in FIG. 4, the streaming audio session Audio1 may be transferred to telephonic device 404, while the streaming video session Video1 may be transferred to telephonic device 406. In one exemplary embodiment, telephonic device 404 may be optimized for streaming audio, while telephonic device 406 may be optimized for streaming video. In one exemplary embodiment, the first telephonic device 402 may also receive a data session Data1, that may be transferred to a third telephonic device 408 that is also registered to the same user as the first telephonic device 402. In one exemplary embodiment, telephonic device 408 may be optimized for streaming data.

In one exemplary embodiment, a user may select a registered telephonic device to be a “requesting telephonic device,” such that pressing a button or a soft-button on the selected telephonic device initiates a transfer process. As discussed herein, the transfer process searches for another telephonic device currently receiving a streaming audio, audio/video, and/or data session that is registered to the same user and is within a defined minimum distance or within a proximity threshold from the requesting telephonic device.

In one exemplary embodiment, so long as the telephonic device currently sending or receiving the streaming audio, audio/video, and/or data session is registered to the same user as an initiating or requesting telephonic device, when the initiating telephonic device is within the defined minimum distance or proximity threshold from the telephonic device currently sending or receiving the streaming audio, audio/video, and/or data session, any network protocol may be utilized to transfer the streaming content. In one exemplary embodiment, the streaming content transfer is transparent to at least one second party also sending and/or receiving the streaming content.

For an exemplary user with multiple registered devices (for example, as supported by SIP), these exemplary embodiments allow the user to move a media session or media stream, such as a voice or video call, and/or a data session, currently active on one device to another device, by initiating this move on to the desired, target device. In response to the request from the target device, the desired media session or stream is located by finding another device registered to the same user nearby the target device (for example, as determined by proximity information included in a presence system or near-field communications linkage such as Bluetooth) currently supporting an active media session or stream that is the desired media session or stream. Once an appropriate media session or stream is found it is transferred to the requesting device, using network protocol requests. As discussed herein, when the media session or stream is transferred, the device originally receiving the media session or stream is disconnected from the media session or stream.

As discussed in detail herein, and described in the method below, to transfer a media session or stream from one device to another using this mechanism, a user activates a “take call” operation on the desired “takeover” device. The desired session or stream may be found by determining a geolocation of the takeover device and finding a session or stream on a nearby device (as determined by its geolocation) registered to the same user or on a device linked to the desired device using near-field communication mechanisms (e.g., Bluetooth). The session or stream is then transferred, utilizing appropriate network protocol commands, to the new device. In one embodiment, transferring the session or stream to the new device also breaks a connection of the session or stream to the original device.

As noted herein, any network protocol may be utilized to transfer the streaming content from a telephonic device currently receiving a streaming audio, audio/video, and/or data session to a request telephonic device. In one exemplary embodiment, when both telephonic devices are SIP devices on a same IP-PBX, the request may be initiated by an exemplary button push on the activating or requesting device and the protocol command effecting the transfer would be a SIP out-of-dialog REFER sent by the IP-PBX to the active device. In one embodiment the REFER may be sent to the initiating device, which may be handled by the IP-PBX if the initiating device cannot handle the transfer. In one exemplary embodiment, when the activating device is a standard cell phone and the current device is a SIP device served by an IP-PBX, the request may be initiated as a text message to a particular destination corresponding to the IP-PBX, which may then send a SIP out-of-dialog REFER sent by the IP-PBX to the current device.

In one exemplary embodiment, when the activating device is a SIP device served by an IP-PBX and the current device is a cell phone, the request might be initiated by an exemplary button push on the activating device. In this exemplary case, the IP-PBX may need an interface of some kind supported by the user's service provider enabling the IP-PBX to query the cell phone's location and then effect the transfer. In one exemplary embodiment, the cellular provider may utilize an API for effecting the interface. In one more exemplary embodiment, when the activating device is a SIP device served by an IP-PBX and the current device is a smart phone, the request may be initiated by an exemplary button push on the activating device. In this exemplary case, the IP-PBX may interact with the user's service provider, as discussed above, or with an application installed on the user's smart phone to determine the location, as well as to effect a transfer. This exemplary implementation may require the application on the smart phone to be able to support these capabilities, meaning the smart phone operating system (OS) would need to expose these capabilities.

In one exemplary embodiment, an activating device and a current receiving device are smart phones with Bluetooth (or some other near field communication channel) capability. The request may be initiated by an exemplary button push on the activating device. In this exemplary case, the activating device may request via a near field communication channel that the active device effect a transfer to the initiating device.

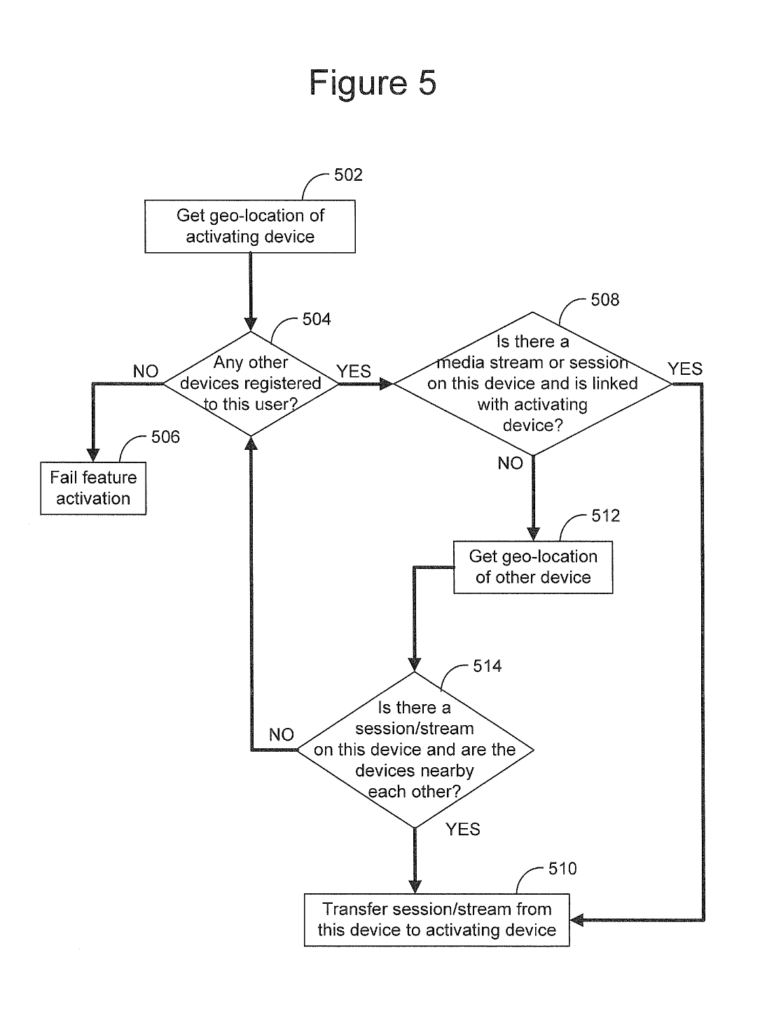

In the method illustrated in FIG. 5, it is assumed that a user has at least two of the following devices: an analog phone, a PC-based soft phone, a traditional cell phone, or a smart cell-phone, for example. The take-over feature may be activated by a hard or soft button, or a dial access code. In any case (from any device), when activated, the steps of the flow diagram are taken. Therefore, as discussed herein, exemplary embodiments of the present disclosure provide a multimedia content transfer process based upon physical proximity of two involved devices. The exemplary transfer process is not limited to two devices, and the exemplary process provides common “pull” feature operations, e.g., the call is “taken over” on the desired device, regardless of how the call was initiated.

In one exemplary embodiment, the transfer option is only available for initiation when there is a current audio, audio/video, and/or data session on another device available for transfer. In other words, the take-over feature will only be offered to a user when there is a current session available for transfer to the initiating device. For example, a soft button on the initiating device may be grayed out when no session is available for transfer.

FIG. 5 illustrates steps to an exemplary process for transferring a telephone call, multimedia, and/or data session from one telephone device to another telephone device. As discussed herein, in one exemplary embodiment, the activating or requesting device (e.g., the device requesting the call transfer) is the device that will receive the call, stream or session. As illustrated in step 502 of FIG. 5, a geolocation of the activating device is determined. As discussed herein, a geolocation may be a geographical location of a cell phone, an internet-connected computer system, or other telecommunications device where a geographical location may be determined. In one exemplary embodiment, a geolocation of a device may be determined by associating a physical location of the device with an interne protocol (IP) address, an RFID wireless connection, a Wi-Fi access location, or GPS coordinates of the device, for example. After determining a geolocation for the activating device, the process continues to step 504.

In step 504 of FIG. 5, the exemplary process determines if there are any other telephone devices registered to the user. If there are no other registered devices, the process continues to step 506 of FIG. 5 and the transfer attempt fails. As discussed herein, in one embodiment, any number of telephone devices may be registered to a user. In one embodiment, only telephone devices registered to a common user may transfer a call, stream or session from one device to another. If there are other telephone devices registered to the user the process continues to step 508 of FIG. 5. In one exemplary embodiment, a registered device is selected from a plurality of registered devices.

In step 508 of FIG. 5, the process determines whether the selected device is linked with a near-field connection or Bluetooth connection to the activating device and whether the selected device is currently receiving a multimedia stream or session. If a selected device is linked to the activating device and is currently receiving a multimedia stream or session, the process continues to step 510 of FIG. 5. If the selected device is not linked to the activating device or there is no current multimedia stream or session received by the selected device, the process continues to step 512 of FIG. 5.

In step 512 of FIG. 5, a geolocation of the selected device is determined. After determining a geolocation of the selected device, the process continues to step 514 of FIG. 5.

In step 514 of FIG. 5, the process determines whether there is a session or stream currently being received by the selected device and whether the selected device is physically near the activating device. In one exemplary embodiment, a proximity of the activating device and the selected device may be determined by comparing geolocations of the activating device and the selected device. If the selected device is within a proximity threshold of the activating device and the selected device is receiving a current session or stream, the process continues to step 510 of FIG. 5. If the selected device is not within the proximity threshold of the activating device or the selected device is not receiving a current session or stream, the process continues to step 504 and determines if there is another device registered to the user. In 510 of FIG. 5, the current stream or session is transferred from the selected device to the activating device. As discussed herein, transferring the stream or session from the selected device to the activating device breaks the connection of the stream or session to the selected device.

In one exemplary embodiment, a list of registered devices may be cycled through as the process searches for a current stream or session received by a registered device in proximity to the activating device. In one exemplary embodiment, when all of the registered devices have been selected the process continues to step 506 of FIG. 5 and the process fails. In one exemplary embodiment, the process may be repeated when the geolocation of the activating device changes if a registered device with a current stream or session has not yet been found within a proximity threshold of the activating device.

In another embodiment, rather than pulling a call or content stream to a desired device, a content stream may be pushed from the current device to a new target device using a manually initiated transfer operation so long as the two devices are within the defined minimum distance or proximity threshold.

As discussed herein, a primary benefit of exemplary embodiments of the disclosure is that a content stream may be transferred regardless of how the content stream was initially established (e.g., regardless of whether it was an incoming or outgoing call from the point of view of the current device). As also discussed herein, another primary benefit is that these exemplary embodiments and processes offer increased security since any handoff mechanism requires physical proximity between the two involved devices.

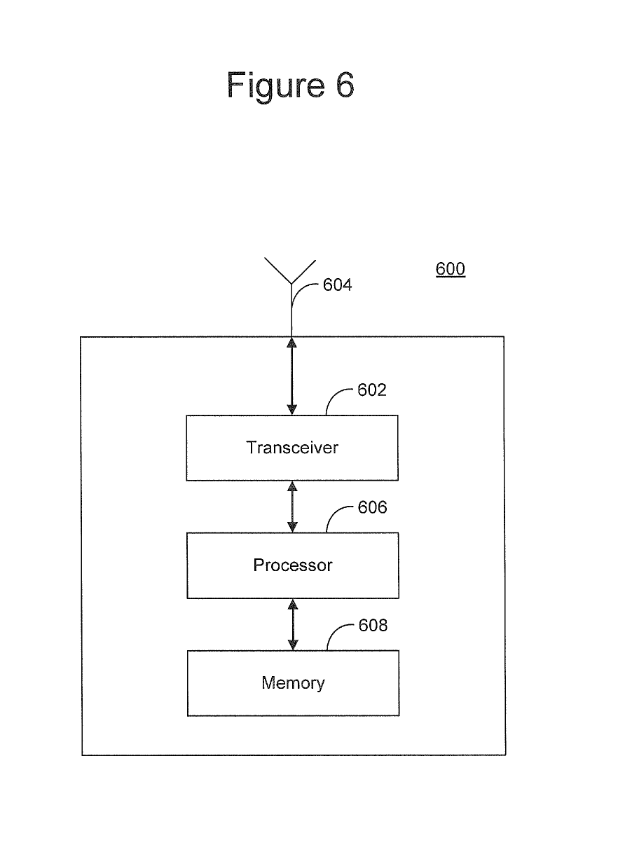

FIG. 6 illustrates an exemplary wireless telephonic device 600. The wireless telephonic device 600 may be for example, a cell phone, a smart phone, a wireless enabled tablet or other portable computing device. As illustrated in FIG. 6, an exemplary wireless telephonic device 600 comprises a transceiver 602 interconnected to an antenna 604 and a process 606. As also illustrated in FIG. 6, the processor 606 is interconnected to the transceiver 602 and a memory 608. In one exemplary embodiment, the transceiver 602 is operable to send and receive audio, audio/video, and/or data sessions. As discussed herein, in one exemplary embodiment, the processor 606 is operable to initiate a transfer request so that a current stream or session currently received by a second device may be transferred to the wireless telephonic device 600. As also discussed herein, the stream or session transfer may be executed when the wireless telephonic device 600 is within a proximity threshold of the second device. In one embodiment, the stream or session transfer may be executed when the wireless telephonic device 600 is within a determined distance from the second device. In one embodiment, the stream or session transfer may be executed when the wireless telephonic device 600 is communicatively coupled to the second device by a near field communications connection or a Bluetooth communications connection.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a nonvolatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure.

Although certain preferred embodiments and methods have been disclosed herein, it will be apparent from the foregoing disclosure to those skilled in the art that variations and modifications of such embodiments and methods may be made without departing from the spirit and scope of the disclosure. It is intended that the disclosure shall be limited only to the extent required by the appended claims and the rules and principles of applicable law.

What is claimed is:

1. A method for transferring a data stream, the method comprising:
a first device determining a proximity to a second device;
the first device initiating a command to terminate a data stream received by the second device via a network when the proximity is below a threshold; and
the first device initiating a command to transfer the data stream via the network so that first device receives the data stream.

2. The method of claim 1, wherein the first device and the second device are registered to a user, wherein a registration comprises a unique user identification associated with the user.

3. The method of claim 1, wherein the network comprises at least one of:
a public switched telephone network (PSTN);
a voice over internet protocol (VoIP) service;
an internet protocol private branch exchange (IP-PBX);
a web-based real-time communication endpoint;
a cellular network; and
a private branch exchange (PBX).

4. The method of claim 1, wherein determining a proximity to a second device comprises determining a location of the first device and a location of the second device, and wherein determining a location comprises associating a physical location of a device with at least one of:
an internet protocol (IP) address;
a radio frequency identification (RFID) wireless connection;
a Wi-Fi access location;
GPS coordinates of the device;
Wi-Fi triangulation; and
cellular network triangulation.

5. The method of claim 1, wherein the proximity is below the threshold when the first device and the second device are at least one of:
connected to a same Wi-Fi access point;
linked via a Bluetooth connection; and
linked via a near-field communication connection.

6. The method of claim 1, wherein transferring the data stream to the first device comprises executing a call transfer request using one of:
session initiation protocols (SIP) for voice over internet protocol; and
public switched telephone network (PSTN) protocols.

7. The method of claim 1, wherein a data stream carried by the network comprises one of:
a voice call;
an audio/video session;
data session; and
a multimedia session.

8. The method of claim 1, wherein terminating the data stream received by the second device comprises executing a call transfer request using one of:
session initiation protocols (SIP) for voice over internet protocol; and
public switched telephone network (PSTN) protocols.

9. A communications apparatus comprising:
a transceiver operable to receive a data stream via a network; and
a processor coupled to the transceiver, wherein the processor is operable to determine a proximity to a second communications apparatus, wherein the processor is further operable to initiate a command to terminate a first data stream received by the second communications apparatus via the network when the proximity is below a threshold, and wherein the processor is further operable to initiate a command to transfer the first data stream via the network so that the communications apparatus receives the first data stream.

10. The apparatus of claim 9, wherein the network comprises at least one of:
a public switched telephone network (PSTN);
a voice over internet protocol (VoIP) service;
an internet protocol private branch exchange (IP-PBX);
a web-based real-time communication endpoint;
a cellular network; and
a private branch exchange (PBX).

11. The apparatus of claim 9, wherein determining a proximity to the second communications apparatus comprises determining a location of the communications apparatus and a location of the second communications apparatus, and wherein determining a location comprises associating a physical location of a communications apparatus with at least one of:
an internet protocol (IP) address;
a radio frequency identification (RFID) wireless connection;
a Wi-Fi access location;
GPS coordinates of the device;
Wi-Fi triangulation; and
Cellular network triangulation.

12. The apparatus of claim 9, wherein the proximity is below the threshold when the communications apparatus and the second communications apparatus are at least one of:
connected to a same Wi-Fi access point;
linked via a Bluetooth connection; and
linked via a near-field communication connection.

13. The apparatus of claim 9, wherein transferring the data stream to the communications apparatus comprises executing a call transfer request using one of:
session initiation protocols (SIP) for voice over internet protocol; and
public switched telephone network (PSTN) protocols.

14. The apparatus of claim 9, wherein the communications apparatus comprises one of:
a cell phone;
an analog phone;
a smart cell phone;
soft phones utilizing VoIP services; and
video conferencing devices.

15. The apparatus of claim 9, wherein terminating the first data stream received by the second communications apparatus comprises executing a call transfer request using one of:
session initiation protocols (SIP) for voice over internet protocol; and
public switched telephone network (PSTN) protocols.
